(19) United States
(12) Patent Application Publication
(10) Pub. No.: US 2004/0143812 A1
(43) Pub. Date: Jul. 22, 2004

(54) Automatic software design tool for building web and other applications wherein components are linked through connected command and control and data variables

(76) Inventors: Vladimir Bernstein, East Windsor, NJ (US); Andrei Afanassenkov, Hightstown, NJ (US)

Correspondence Address: Vladimir Bernstein, 40 Pierce Road, East Windsor, NJ, 08520, US

(21) Appl. No.: 10/755,813

(22) Filed: Jan. 12, 2004

Related U.S. Application Data
(60) Provisional application No. 60/440,250, filed on Jan. 14, 2003.

(51) Int. Cl. G06F 9/44

(52) U.S. Cl. 717/101; 717/120

(57) ABSTRACT

This invention provides a method to build a computer program project, The method includes using a GUI to select components; and linking at least two components via at least one exposed variable of each component. At least one component may be a previously built computer program project. This invention also provides a method to execute a computer program project. This method includes, during operation of an active component (Componentₐ), detecting a change in a Valueₐ of a Variableₐ and transferring from Componentₐ to a Project Variable Monitor the new Valueₐ of Variableₐ, a Variable Change Notification and a Remote Connections Table (RCT) of Variableₐ. The RCT stores a list of other components and their variables that were linked to Variableₐ during the creation of the computer program project. In response to receiving the information from Componentₐ, a next step of the method notifies the other components (those identified in the RCT) of the Valueₐ of Variableₐ and the Identifiers of the variables to be updated to Valueₐ. A next step is performed at the notified components, and updates the value of each identified variable to Valueₐ.

### CROSS REFERENCE TO RELATED APPLICATIONS

This application claims priority based on U.S. Provisional Patent Application Serial No. 60/440,250, filed Jan. 14, 2003, entitled “AUTOMATIC SOFTWARE DESIGN TOOL FOR BUILDING WEB AND OTHER APPLICATIONS WHEREIN COMPONENTS ARE LINKED THROUGH CONNECTED COMMAND AND CONTROL AND DATA VARIABLES”, which is incorporated here by reference in its entirety.

### TECHNICAL FIELD

These teachings relate generally to software development tools and systems and, more specifically, application development tools having a graphical user interface (GUI) for enabling a software developer to define and build an application, such as an Internet World Wide Web (WWW) page application, a client/server application, a desktop application, and a database application.

### BACKGROUND

In U.S. Pat. No. 5,566,295, Extensible simulation system and graphical programming method, Cypher et al. describe an extensible simulation system and graphical programming method that enable a simulation user to program the behaviors of objects in a simulation, while purportedly requiring no knowledge of computer programming concepts or languages. The simulation user defines each object's behaviors by creating Graphical Rewrite Rules through programming by demonstration. The user can selectively abstract a given Graphical Rewrite Rule (GRR) such that it applies to states within the simulation according to hierarchical object types and object property conditions. The extensible simulator includes an object source, a simulation viewer, a GRR editor, an action recorder, an abstractor, a drawing editor, an object property editor, an object rule viewer, a subroutine editor and a simulation execution controller. A graphical programming method has steps of selecting an object for which a GRR is to be defined; establishing a simulation context corresponding to the GRR; defining for the GRR a set of actions to be performed by or upon one or more objects within the simulation context, each action defined through programming by demonstration; automatically recording a computer program step sequence for each action defined; and allowing the GRR to be abstracted.

In U.S. Pat. No. 5,760,788, Graphical programming system and method for enabling a person to learn text-based programming, Chainini et al describe a graphical programming application is provided run under a graphic user interface operating system. When running the graphical programming software application, a user can select a graphic object and an associated event, and define actions that occur when the event happens, to develop or modify the graphical program as desired. In addition to a graphic editor view mode, the user may optionally view a plain text listing corresponding to the graphic program, or use a Visual Basic for Applications (VBA) code editor in which statements corresponding to the graphic program are displayed. The user may also activate a mode in which both code editors are visible at one time on the screen, so that changes made to the VBA statements are immediately reflected in the graphical program and vice versa. Since the user is able to view the VBA code that corresponds to the graphical program steps, proficiency in programming with VBA text-based code is said to be more rapidly developed.

In U.S. Pat. No. 6,225,998B1, Visual design of workflows for transaction processing, Okita et al. describe a system and a method for displaying visual primitives of a transaction flow through a transaction processing system. A visual representation of a transaction flow containing visual primitives is accessed from a storage device by a digital computer. The digital computer is then used to display the visual primitives of the transaction flow an a visual display. The visual primitives can be dynamically sized and may display properties of each visual primitive. Configuration information associated with the transaction flow is also shown on the visual display.

In U.S. Pat. No. 6,366,300B1, Visual programming method and its system, Ohara et a!. describe a system wherein a user is allowed to automatically generate a program by using a visual programming method. A system is employed for automatically generating a program wherein an object selector is used for selecting a behavioral graphical object defining the behavior of a load connected thereto, a behavior selector is used for selecting the type of behavior of the behavioral graphical object, and a relevant object selector is used for selecting relevant graphical objects related to the behavior of the behavioral graphical object. The system also has a behavioral rule setting device for setting behavioral rules of the behavioral graphical object. A behavioral characteristic selector is used for selecting a behavior of a behavioral graphical object selected by using a behavioral object selection unit, a behavioral condition setting unit is used for setting conditions for the behavior of the behavioral graphical object, and a relevant object selection unit is used for defining a relation.

The foregoing systems are exemplary of prior art systems and methods that attempt to provide an automatic program development environment wherein, ideally, a user is enabled to define and develop a computer software program without having had any significant amount of prior computer programming experience or training. Application areas where this need is especially important include web-based software, such as the development of web sites, and database software, such as query engines.

Prior to this invention, however, this long-felt need in the prior art has not been realized to its fullest and most developed extent.

### SUMMARY OF THE PREFERRED EMBODIMENTS

The foregoing and other problems are overcome, and other advantages are realized, in accordance with the presently preferred embodiments of these teachings.

In one aspect this invention provides a method to build a computer program project, and includes using a GUI to select components; and linking at least two components via at least one exposed variable of each component. At least one component may be a previously built computer program project.

In a further aspect this invention provides a method to execute a program project containing one or more Components_{1 . . . n}, each containing one or more Variables_{1 . . . n}, with each Variable_{1 . . . n} containing one Value and having associated therewith a list of Universal Identifiers of Connected Variables for each Value. In the method, and during the operation of the program project when a Component changes the value of any one of its variables (Value of Variableₐ), Variableₐ, detecting the change in Value, uses the functionality of a Project Variable Monitor (Platform) and the list of Universal Identifiers of Connected Variables associated with Variableₐ to locate all connected Variables, for updating the Value of each connected Variable.

In a further aspect this invention provides a method to execute a computer program project. This method includes, during operation of an active component (Componentₐ), detecting a change in a Valueₐ of a Variableₐ and transferring from Componentₐ to a Project Variable Monitor the new Valueₐ of Variableₐ, a Variable Change Notification and a Remote Connections Table (RCT) of Variableₐ. The RCT stores a list of other components and their variables that were linked to Variableₐ during the creation of the computer program project. In response to receiving the information from Componentₐ, a next step of the method notifies the other components (those identified in the RCT) of the Valueₐ of Variableₐ and the Identifiers of the variables to be updated to Valueₐ. A next step is performed at the notified components, and updates the value of each identified variable to Valueₐ.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a logical diagram of a project showing relationships between a hierarchy of 20 authoring tools, components and exposed component variables, wherein some of the variables are linked between components, and where the variables are logically contained within and managed by a target platform;

FIG. 2 is another logical diagram, similar to FIG. 1, and showing that certain components may be projects in their own right;

FIG. 3 shows an arbitrary component and certain of the internal software structure of the component;

FIG. 4 illustrates the presently preferred process for notifying the target platform of a change in a variable in a component A, and for updating all linked variables in other components; and

FIG. 5 is a logic flow diagram illustrating the operation of notifying the target monitor of a change in a variable of an active component, and the notification of all connected components of the variable change for enabling the connected components to update their corresponding variables.

### DETAILED DESCRIPTION OF THE PREFERRED EMBODIMENTS

The following discussion is intended to be read in conjunction with the document found in Appendix A, entitled, “Target 2.0 Building database driven web applications with no programming, Technology Concept”, SIMX Corporation (2002). The document found in Appendix A forms a part of the disclosure of this patent application, and is incorporated herein in its entirety.

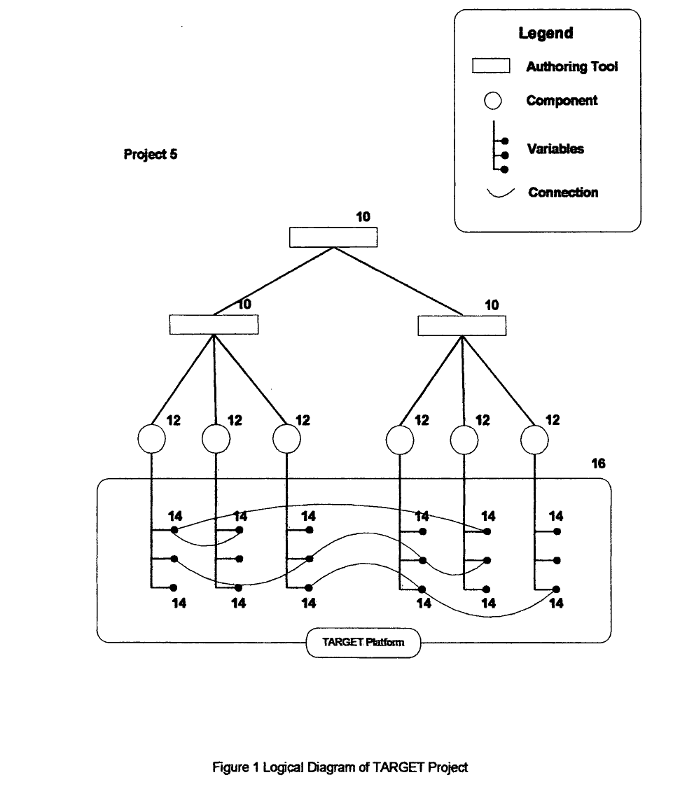

FIG. 1 is a logical diagram of a project 5 showing relationships or linkages between a hierarchy of authoring tools 10, components 12 and exposed component variables 14. Note that some of the variables 14 are linked between components 12. This linking is performed by the user by interacting with a GUI using mouse-based or equivalent techniques for selecting a first variable 14, and then indicating a second variable 14 to which the first variable is linked. The components 12 expose their respective variables 14 in the manner shown, and the variables 14 are logically contained within and are managed by a target platform 16. This linkage of variables 14 is an important aspect of this invention, as it enables a computer program to be constructed in a rapid manner from a plurality of program units. The linkage between two or more variables 14 is an indication of the equivalence of the linked variables. By being so linked, and thus equivalent, a change in one of the variables during execution of the program is automatically propagated to all of the linked variables 14 by the operation of the target platform 16. These features of the invention are described further below in reference to FIGS. 7, 8 and 9.

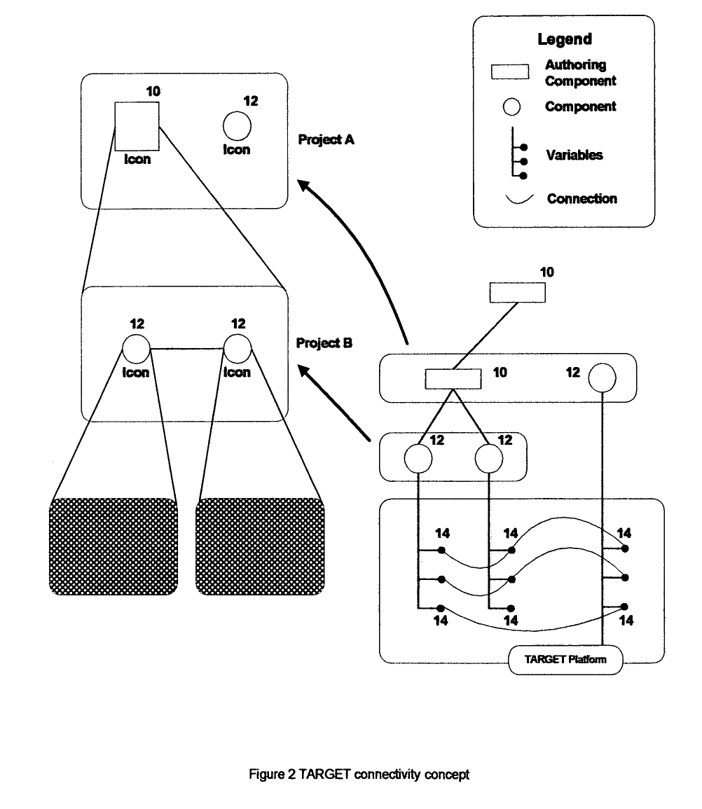

FIG. 2 is another logical diagram, based on FIG. 1, that shows that certain components 10 may be a project 5. That is, an already defined project 5, such as the one shown in FIG. 1, can be selected and dropped as an authoring component 10 into another project, and exposed variables 14 that are relevant to the interface to the second project are then linked by the user as needed.

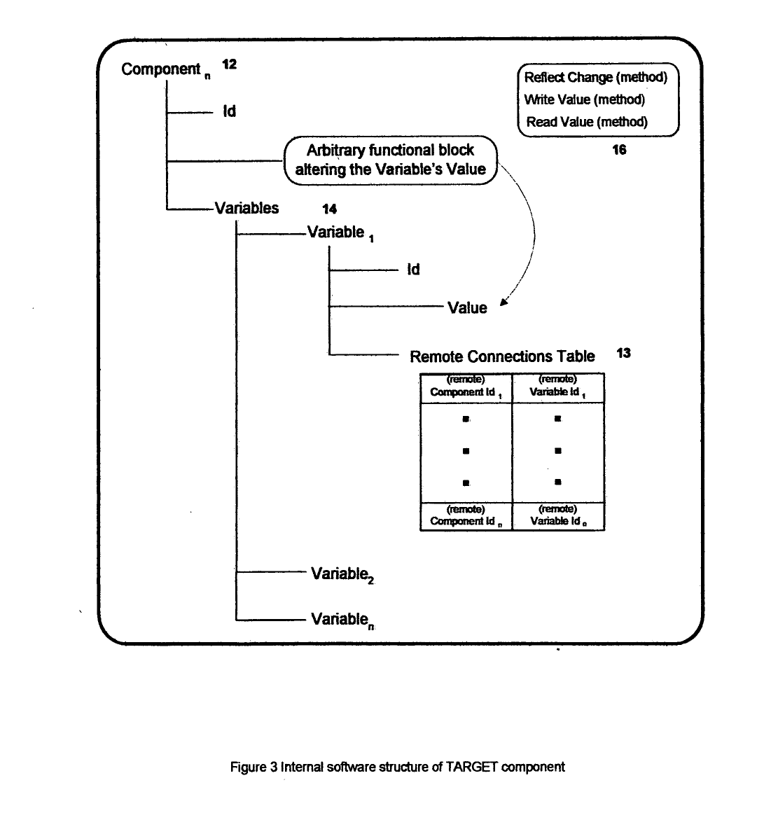

FIG. 3 shows an arbitrary component and certain of the internal software structure of an exemplary component 12. The componentₙ has a component identifier (Id), an arbitrary functional block (Function) that is capable of altering the Value of a particular variable, and at least one variable 14. A given one of the variables 14, e.g., Variable1, has a variable Id, a Value, and a Remote Connections Table (RCT) 13 whereby the linkages with the variable of other components 12 are recorded. The linkages are recorded in tabular fashion so as to include the remote component's Id, and the variable's Id at the remote component that this variable (Variable1) is linked to.

Using this structure the target platform 16 is enabled perform certain methods, including a Reflect Change method, a Write Value method and a Read Value method. An end result is that all connected (linked) variables have at all times the same value.

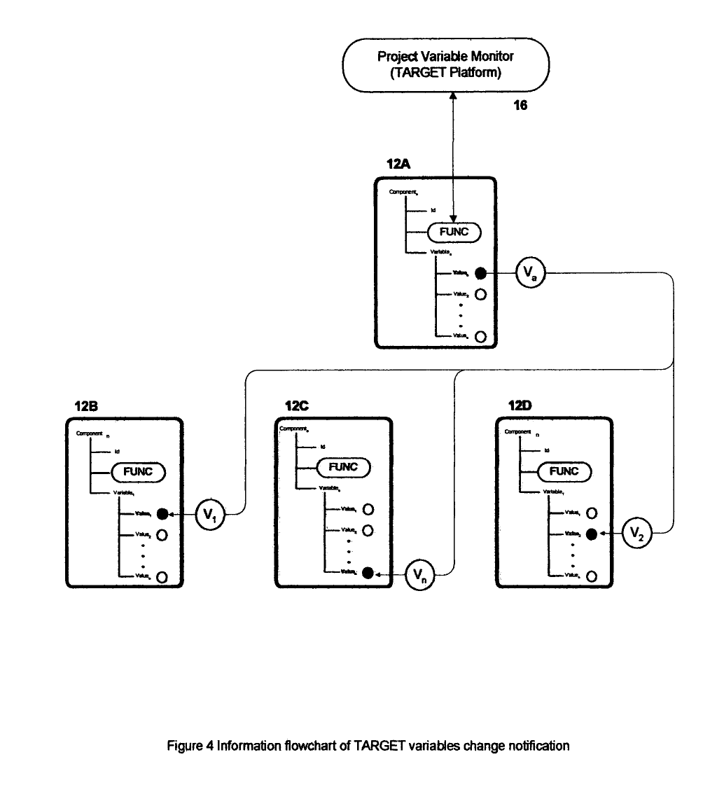

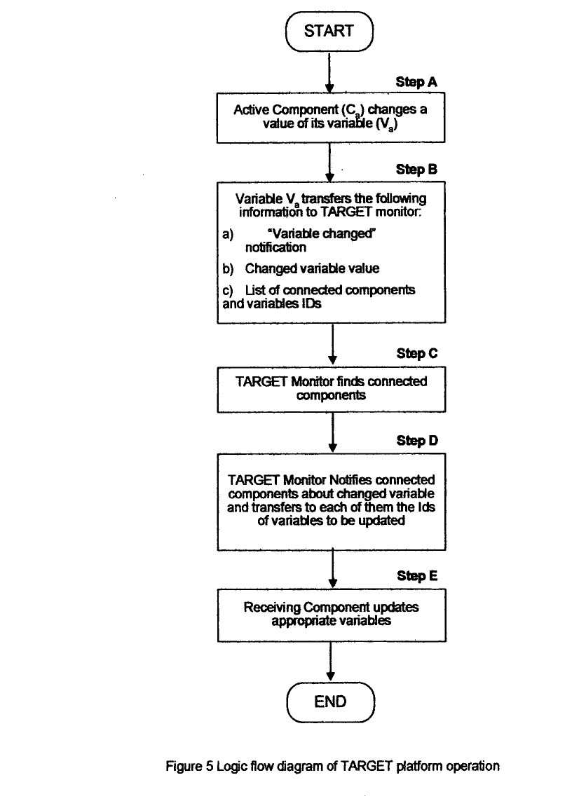

FIG. 4 illustrates the presently preferred process for notifying the target platform of a change in a variable in a component A, and for updating all linked variables in other components. Referring as well to the logic flow diagram of FIG. 5, the process begins when the operation of an active component (Componentₐ) changes the Valueₐ of a Variableₐ (Step A). In response, Componentₐ transfers to a Project Variable Monitor of the platform 16 the new Valueₐ of Variableₐ, along with a Variable Change Notification indicator or message and the RCT 13 (Step B). This can be accomplished by the Componentₐ calling a Platform method. From FIG. 3 it will be remembered that the RCT 13 stores a list, for a particular variable, of all connected components/variables. In this example assume that Variableₐ of component 12A is linked to Variable₁ of component 12B, Variableₙ of component 12C and to Variable₂ of component 12D. In response to receiving the transmitted information from component 12A, the Project Variable Monitor 16 determines the connected components (Step C) and this information is used for notifying components 12B, 12C and 12D of the Valueₐ of Variableₐ and the Ids of the variables to be updated to the new value (Step D). When each component becomes active they update the identified variables Varaiable₁, Variableₙ and Variable₂, respectively, to the new value Valueₐ of Variableₐ (Step E).

As an example, assume that component 12A has a variable m, where ,m=b+c, and that component 12B has a variable n given by n=k/m. In this case at least variable m is an exposed variable of component 12A (variables b and c may or may not be), and at least variable m is an exposed variable of component 12B (variables k and n may or may not be). During the specification phase the user links the exposed variable m of component 12A to the exposed variable m of component I 2B, and this linkage is recorded in the RCT 13 of component 12A for the variable m. While component 12A is active assume that the expression m=b+c is evaluated, and that a change results in the value of m. The change in the value of m is then sent to the Project Variable Monitor 16A, along with the RCT 13 of variable m, with the Variable Change Notification. The end result is that component 12B is informed of the new value of m, and in response evaluates n=k/m, thereby ensuring that the value of n is updated. Of course, if variable n is linked to an exposed variable in another component, for example components 12C and 12D, then the change in value of n is made known to the Project Variable monitor 16A by component 12B, and the new value of n is propagated to components 12C and 12D in the same manner.

It can be appreciated that this invention does not provide a new programming language for use in application development, but instead provides an approach where there are hierarchies of objects and components that are linked together by variables. The procedure is one that is based on actions, such as a change in the value of a variable of a component that is propagated to all user-defined linked variables of other components.

One important purpose of this invention is to enable a user to rapidly define an application to obtain usable reports or operations The user is then enabled to define simple terms that are descriptive of the underlying data (e g , data source, table, file), and to then define simple procedures for dealing with data sources, tables and/or files These procedures can then be linked via one or more exposed variables, and if desired re-used and linked into a larger procedure.

While described in the context of presently preferred embodiments, those skilled in the art will realize that changes and form and details may be made to these embodiments, and that all such changes will still fall within the scope of this invention.

What is claimed is:

1. A method to build a computer program project, comprising:
using a GUI to select components; and
linking at least two components via at least one exposed variable of each component.

2. A method as in claim 1, where at least one component is a project.

3. A method to execute a program project containing one or more Components_{1 . . . n}, each containing one or more Variables_{1 . . . n}, with each Variable_{1 . . . n} containing one Value and having an associated list of Universal Identifiers of Connected Variables for each Value, which,
during the operation of the program project when a Component changes the value of any one of its variables (Value of Variableₐ),
Variableₐ, detecting the change in Value, uses the functionality of a Project Variable Monitor Platform) and the list of Universal Identifiers of Connected Variables associated with Variableₐ to locate all connected Variables, and
updating the Value of each connected Variable.
